(19) United States
(12) Patent Application Publication
(10) Pub. No.: US 2006/0260570 A1
(43) Pub. Date: Nov. 23, 2006

(54) Crankshaft rotary valve

(76) Inventor: Jerome Matthew James, Orlando, FL (US)

Correspondence Address: Jerome M James, 3870 Cloud Dr, Colorado Springs, CO, 80920, US

(21) Appl. No.: 11/414,876

(22) Filed: May 1, 2006

Related U.S. Application Data
(60) Provisional application No. 60/682,024, filed on May 17, 2005.

(51) Int. Cl. F02B 33/00; F02B 25/00

(52) U.S. Cl. 123/73 V; 123/65 V

(57) ABSTRACT

A crankshaft rotary valve that controls fluid flow between a port located circumferentially on the crankshaft and a crankcase chamber formed by a piston, cylinder, crankcase and crankshaft. As the crankshaft rotates, a channel in the crankshaft communicates with the port and allows fluid flow to pass through the channel into a passageway that communicates between the channel and the crankcase chamber. The diameter of the crankshaft bearing surface is at least the stroke distance to greatly simplify manufacturing and assembly.

### CROSS-REFERENCE TO RELATED APPLICATIONS

This application claims an invention which was disclosed in Provisional Application No. 60/682024, filed May 17, 2005, entitled “2-Cycle Engine”. The benefit under 35 USC §119(e) of the U.S. provisional application is hereby claimed, and the aforementioned application is hereby incorporated herein by reference.

### BACKGROUND OF THE INVENTION

1. Field of the Invention

The present invention generally relates to engines and pumps and, more particularly, to an engine or pump where flow can be controlled between a port and a crankcase chamber by means of a crankshaft rotary valve.

2. Description of Related Art

Crankshaft rotary valves are very common in most single cylinder 2-cycle engines. A rotary valve operates by communicating with an intake port and a crankcase chamber. As the piston moves up, air and fuel are drawn into the crankcase chamber through a passageway in the crankshaft and intake port. The crankshaft rotary valve then closes as the crankshaft rotates and the air-fuel mixture is then compressed by the downward movement of the piston. The intake timing is set by the channel in the crankshaft rotary valve.

The difficulty in building multi-cylinder 2-cycle engines using the current crankshaft rotary valve is that the crankshaft and crankcase are difficult to manufacture and assemble due to the crankshaft offsets and bearing surfaces between the crankcase and crankshaft. This requires that the crankcase vary in size to accommodate the bearing surfaces and crankshaft offsets that the piston connecting rods are connected to. By enlarging the diameter of the bearing surface of the crankshaft to a minimum of the stroke distance, the diameter of the crankcase can be one diameter throughout the engine to greatly simplify manufacturing and assembly.

### BRIEF SUMMARY OF THE INVENTION

### BRIEF DESCRIPTION OF THE SEVERAL VIEWS OF THE DRAWING

FIG. 1 shows an exploded view of the crankshaft rotary valve as used in a pressurized air engine.

FIG. 2 shows an exploded view of the crankshaft rotary valve as used in a 2-cycle engine.

### DRAWINGS—REFERENCE NUMERALS

10 Cylinder

12 Piston

14 Connecting rod

16 Crankcase

18 Intake Port

20 Crankshaft Rotary Valve—Crankshaft

22 Channel

24 Passageway

26 Exhaust Port—2-cycle Engine

28 Transfer Port

30 Cylinder Head

32 Ignition Source

34 Exhaust Port—Air Pressure Engine

### DETAILED DESCRIPTION OF THE INVENTION

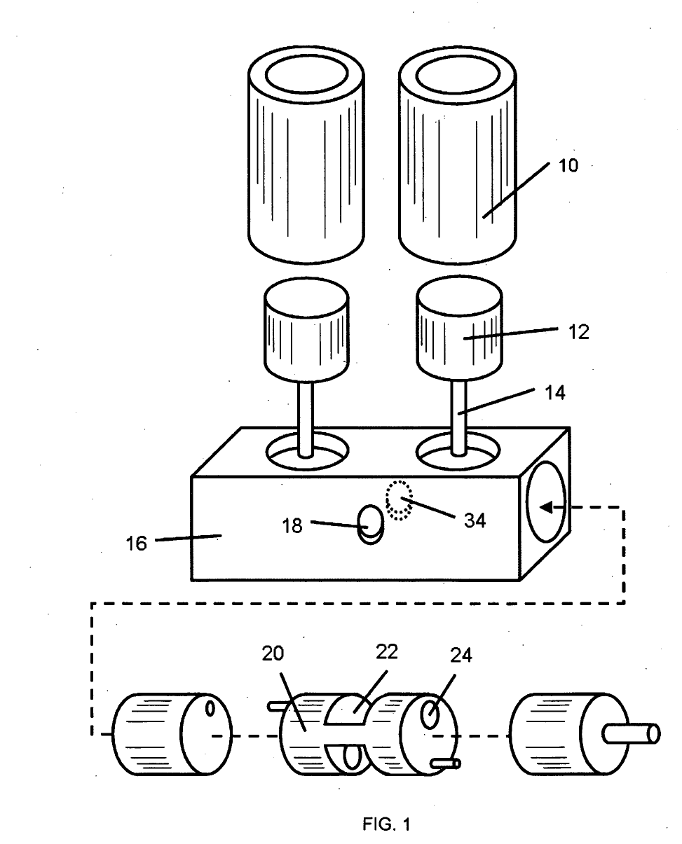

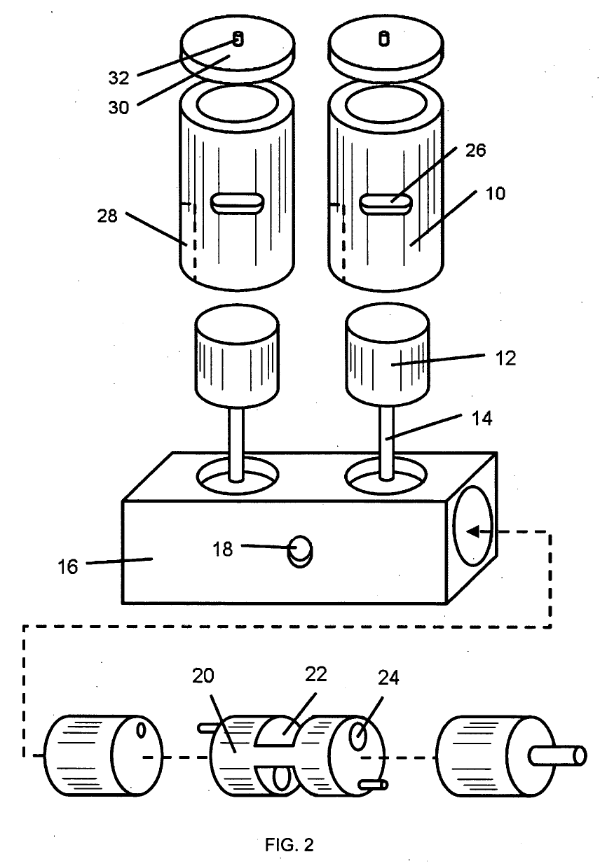

FIG. 1 shows the crankshaft rotary valve (20) in the most basic configuration, a steam engine or pressurized air engine. This configuration can also be used as a pump by providing rotation to the crankshaft from an external power source. By adding a 2-cycle exhaust port (26), cylinder heads (30), ignition source (32), and transfer port (28), the basic configuration can be made into a 2-cylce engine as seen in FIG. 2.

The steam engine configuration consists of a piston (12) that reciprocates within a cylinder (10). The piston (12) is attached to a crankshaft (20) via a connecting rod (14). The crankshaft (20) rotates in a crankcase (16) and converts the reciprocal motion of the piston (12) into rotary motion. The stroke distance of the engine is the distance between the piston (12) at the highest top position and the lowest bottom position in the cylinder (10). The crankshaft (20) diameter is a minimum of the stroke distance. The crankshaft (20) contains a channel (22) that is located circumferentially on the crankshaft (20) that communicates with an intake port (18). The crankshaft (20) also contains a passageway (24) that connects the channel (22) to the face of the crankshaft (20). A crankcase chamber is formed by the cylinder (10), crankcase (16), piston (12) and crankshaft (20).

The cycle begins with the channel (22) aligned to the intake port (18). Pressurized air passes through the intake port (18), into the channel (22) then through the passageway (24) to the underside of the piston (12). The pressurized air forces the piston (12) upward and rotates the crankshaft (20). As the crankshaft (20) rotates and the piston (12) reaches the upper most position, the intake port (18) is closed. As the crankshaft (20) continues to rotate, the exhaust port (34) on the opposite side of the crankcase (16) opens up. As the piston (12) continues to move downward it exhausts the air through the passageway (24) into the channel (22) and out through the exhaust port (34). The cycle then repeats.

An alternative embodiment of the crankshaft rotary valve is shown in FIG. 2. By adding a 2-cycle exhaust port (26), cylinder head (30), ignition source (32) and transfer port (28) the crankshaft rotary valve is useful in 2-cycle, or 2-stroke, engines. The cycle begins with the piston (12) at the upper most position. The ignition source (32) ignites the compressed fuel air mixture in the cylinder (10) and forces the piston (12) down. As the piston (12) moves down it rotates the crankshaft (20) while also compressing the air fuel mixture in the crankcase chamber. As the piston (12) moves downward, it exposes the exhaust port (26) and exhausts the combusted air fuel mixture. As the piston (12) continues downward it exposes the transfer port (28) in the side wall of the cylinder (10) and the compressed air fuel mixture in the crankcase chamber is forced from the crankcase chamber through the transfer port (28) and into the cylinder (10) above the piston (12). As the piston (12) reverses direction and moves upward, it closes the transfer port (28) then the exhaust port (26) and creates a vacuum in the crankcase chamber. As the crankshaft (20) rotates, the channel (22) aligns with the intake port (18) and the vacuum in the crankcase chamber draws in a new charge of air and fuel. As the piston reaches the upper most position, the crankshaft (20) rotates and the channel (22) is no longer aligned with the intake port (18) and is closed. Once the piston (12) reaches the uppermost position, the air fuel mixture is compressed in the cylinder (10) and ignited by the ignition source (32). The cycle then repeats.

I claim:

1. A device comprising:
a. means for containing a volume;
b. means for varying said volume through reciprocal motion;
c. means for converting said reciprocal motion into rotary motion;
d. means for housing said means for converting reciprocal motion into said rotary motion;
e. means for connecting said means for varying said volume through reciprocal motion and means for converting said reciprocal motion into rotary motion;
f. means for providing intake or exhaust, circumferentially positioned to said means for converting reciprocating motion into circular motion;
g. means for controlling fluid flow between said means for housing said means for converting said reciprocal motion into said rotary motion and said means for converting said reciprocal motion into said rotary motion;

2. The device in accordance with claim 1, wherein said means for providing a volume comprises a cylinder.

3. The device in accordance with claim 1, wherein said means for varying said volume through said reciprocal motion comprises a piston.

4. The device in accordance with claim 1, wherein said means for connecting said means for varying said volume through reciprocal motion and means for converting said reciprocal motion into rotary motion comprises a connecting rod.

5. The device in accordance with claim 1, wherein said means for housing said means for converting said reciprocal motion into said rotary motion comprises a crankcase.

6. The device in accordance with claim 1, wherein said means for providing intake or exhaust, circumferentially positioned to said means for converting reciprocating motion into circular motion comprises a port.

7. The device in accordance with claim 1, wherein said means for converting said reciprocal motion into said rotary motion comprises a crankshaft:
a. A crankshaft as defined in claim 7 wherein the diameter of the bearing surface is at least the distance of the stroke distance;
b. A crankshaft as defined in claim 7 wherein a channel is peripherally located to said crankshaft and communicates between said port and a passageway;
c. A crankshaft as defined in claim 7 wherein said passageway communicates between said channel and said crankshaft end;

8. A device in accordance with claim 1, wherein the number of cylinders is at least two.
